(19) United States
(12) Patent Application Publication
(10) Pub. No.: US 2023/0378559 A1
(43) Pub. Date: Nov. 23, 2023

(54) Method for Controlling Maintenance Charging, and Power Storage System

(71) Applicants: Furukawa Electric Co., Ltd., Tokyo (JP); The Furukawa Battery Co., Ltd., Yokohama (JP)

(72) Inventors: Hideto Nakamura, Tokyo (JP); Hidaeki Yoshida, Nikko (JP); Toshiyuki Sato, Yokohama (JP)

(21) Appl. No.: 18/362,610

(22) Filed: Jul. 31, 2023

Related U.S. Application Data
(63) Continuation of application No. PCT/JP2022/001837, filed on Jan. 19, 2022.

(30) Foreign Application Priority Data
Feb. 10, 2021 (JP) 2021-019861
Feb. 10, 2021 (JP) 2021-019862

(51) Int. Cl. H01M 10/44; H01M 10/48; H01M 10/42

(52) U.S. Cl. CPC H01M 10/443; H01M 10/486; H01M 10/425; H01M 2010/4271

(57) ABSTRACT

A method for controlling maintenance charging and a power storage system capable of suppressing occurrence of overcharge and insufficient charge in recovery charging are described. Constant voltage charging is performed after constant current charging as the maintenance charging. During the constant voltage charging, whether to continue or terminate the constant voltage charging is determined based on the temperature of the battery and a threshold value. The temperature of the battery is determined using a charging rate calculated from a total charge amount and a total discharge amount of the battery that are calculated from a current value of the battery.

### CROSS-REFERENCE TO RELATED APPLICATION(S)

This application is a continuation of PCT Application No. PCT/JP2022/001837, filed Jan. 19, 2022, the disclosure of which is incorporated herein in its entirety by reference.

### TECHNICAL FIELD

The present invention relates to a method for controlling maintenance charging such as equalizing charging and recovery charging, and to a power storage system.

### BACKGROUND

As illustrated in FIG. 1, in an operation of a lead acid battery, to prevent overdischarge and overcharge, a partial state of charge (PSOC) operation in which the lead acid battery is operated with a residual capacity in a range of about 30% to 90% is performed. The lead acid battery is more resistant to overcharge than other batteries, but at the time of overcharge, corrosion of a positive electrode grid proceeds, and deterioration occurs due to an increase in internal resistance, breakage, or the like.

In such a lead acid battery, maintenance charging, such as equalizing charging and recovery charging, is performed.

When a voltage variation (i.e., a potential difference) occurs in each cell of the lead acid battery, the voltage variation adversely affects the lead acid battery. Thus, the equalizing charging is performed at predetermined intervals for the purpose of equalizing the voltage variation in each cell of the lead acid battery.

In order to fully charge a discharged battery as soon as possible, the recovery charge is performed each time for the purpose of rapidly charging the battery whose capacity has been reduced by discharge to prepare for next discharge.

For the maintenance charging of such a lead acid battery, as illustrated in FIG. 2, a method is employed in which constant current charging (CC charging) is performed, and then constant voltage charging (CV charging) is performed for a predetermined time when a voltage becomes constant. In this case, a condition that a ratio (e.g., a charging rate) between a total charge amount and a total discharge amount becomes a constant value is used as an index of completion of the maintenance charge.

In addition, for example, JP Patent Publication No. 2001-292534 A discloses a method of terminating the CV charging when a current value during the CV charging converges to a constant value during the maintenance charging of a lithium-ion battery.

### SUMMARY

In the conventional maintenance charging as illustrated in FIG. 2, the internal resistance changes depending on temperature conditions, and charge acceptability also changes. Therefore, in the conventional maintenance charging, there is a possibility that overcharge or insufficient charge occurs depending on the temperature conditions, and deterioration progresses.

In addition, even in the method disclosed in JP Patent Publication No. 2001-292534 A, because a magnitude of charging current during the CV charging is affected by the internal resistance, there is a possibility that insufficient charge occurs depending on the temperature conditions.

Therefore, the present invention has been made in view of the above problems, and an object of the present invention is to provide a method for controlling maintenance charging and a power storage system capable of suppressing occurrence of overcharge and insufficient charge during the maintenance charging, such as equalizing charging and recovery charging.

(1) According to a first aspect of the present invention, a method for controlling maintenance charging is provided. The method includes performing constant voltage charging after constant current charging as the maintenance charging of a battery and determining during the constant voltage charging whether to continue or terminate the constant voltage charging based on a temperature of the battery and a threshold value. The temperature of the battery is determined using a charging rate calculated from a total charge amount and a total discharge amount of the battery that are calculated from a current value of the battery.

According to a configuration of the above (1), it is possible to suppress the occurrence of overcharge and insufficient charge during the maintenance charging by determining whether to continue or terminate the constant voltage charging based on the temperature of the battery determined using the charging rate and the threshold value.

(2) In the configuration of the above (1), when performing charging and discharging of the battery including the maintenance charging, the temperature and a current of the battery may be measured. A measured current value may be corrected based on the temperature measured. The total charge amount and the total discharge amount of the battery may be calculated by integrating the current value corrected. The constant voltage charging may be continued when a first charging rate calculated from the total charge amount and the total discharge amount of the battery is less than a first threshold value, and the constant voltage charging may be terminated when the first charging rate is equal to or greater than the first threshold value.

According to a configuration of the above (2), the measured current value may be corrected according to the temperature conditions. Therefore, it is possible to cope with a change in charge acceptability due to a temperature change, thereby reducing overcharge and insufficient charge.

(3) In the configuration of the above (2), a value obtained by multiplying the current value by a temperature correction coefficient set according to the temperature of the battery may be used when correcting the current value.

(4) In the configuration of the above (1), the constant voltage charging may be continued when a second charging rate calculated from the total charge amount and the total discharge amount of the battery is less than a second threshold value according to the temperature of the battery, and the constant voltage charging may be terminated when the second charging rate is equal to or greater than the second threshold value.

According to a configuration of the above (4), the charging rate at which the constant voltage charging is terminated may be changed according to the temperature conditions. Therefore, it is possible to cope with a change in charge acceptability due to a temperature change, thereby reducing overcharge and insufficient charge.

(5) In the configuration of the above (4), a value obtained by multiplying a set value that is a predetermined charging rate by a temperature correction coefficient may be used as the second threshold value.

(6) In any one of the configurations (1) to (5) described above, the battery may be a bipolar lead acid battery.

(7) According to a second aspect of the present invention, a power storage system is provided. The power storage system includes a plurality of storage batteries, a temperature sensor configured to measure a temperature of the battery, a host system configured to perform energy management of the plurality of storage batteries, an assembled battery sensor configured to measure a charging and discharging current and a total voltage of the plurality of storage batteries, and a battery monitoring device configured to perform state determination of the plurality of storage batteries and control charging and discharging including maintenance charging. Constant voltage charging is performed after constant current charging as the maintenance charging. During the constant voltage charging, whether to continue or terminate the constant voltage charging is determined based on the temperature of the battery and a threshold value. The temperature of the battery is determined using a charging rate calculated from a total charge amount and a total discharge amount of the battery that are calculated from a current value of the battery.

### BRIEF DESCRIPTION OF THE DRAWINGS

FIG. 1 is an explanatory diagram illustrating an operational image of a lead acid battery.

FIG. 2 is an explanatory diagram illustrating maintenance charging.

FIG. 3 is a configuration diagram illustrating a power storage system according to a first embodiment of the present invention.

FIG. 4 is a configuration diagram illustrating a system configuration of a battery monitoring device.

FIG. 5 is an explanatory diagram illustrating a cycle of charging and discharging.

FIG. 6 is a flowchart illustrating a method of charging and discharging in a first embodiment.

FIG. 7 is a flowchart illustrating the method of charging and discharging in a second embodiment.

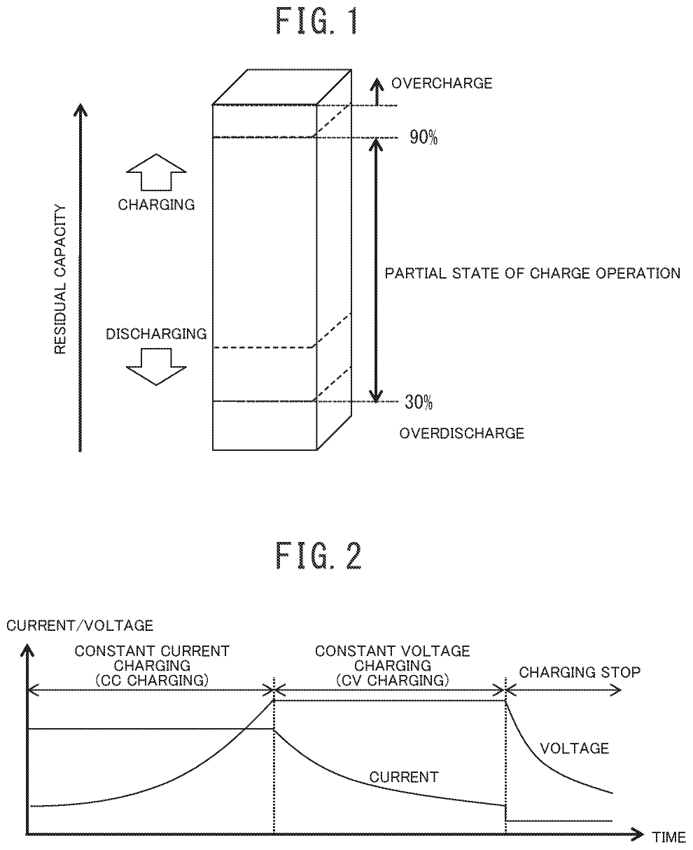

### DETAILED DESCRIPTION

Embodiments of the present invention will be described. Note that the embodiments described below illustrate examples of the present invention. Various changes or improvements can be added to the present embodiments, and embodiments to which such changes or improvements are added can also be included in the present invention.

### First Embodiment

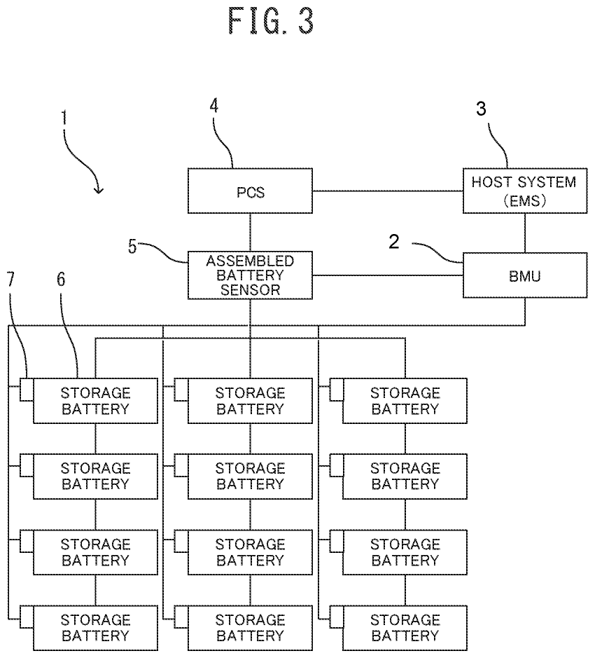

As illustrated in FIG. 3, a power storage system 1 according to a first embodiment of the present invention includes a battery monitoring device 2 (also called a BMU), a host system 3 (also called an EMS), an AC-DC converter 4 (also called a PCS), an assembled battery sensor 5, a plurality of storage batteries 6, and a plurality of temperature sensors 7. Note that, as described later, the power storage system 1 is a system that performs charging and discharging including maintenance charging of the plurality of storage batteries 6.

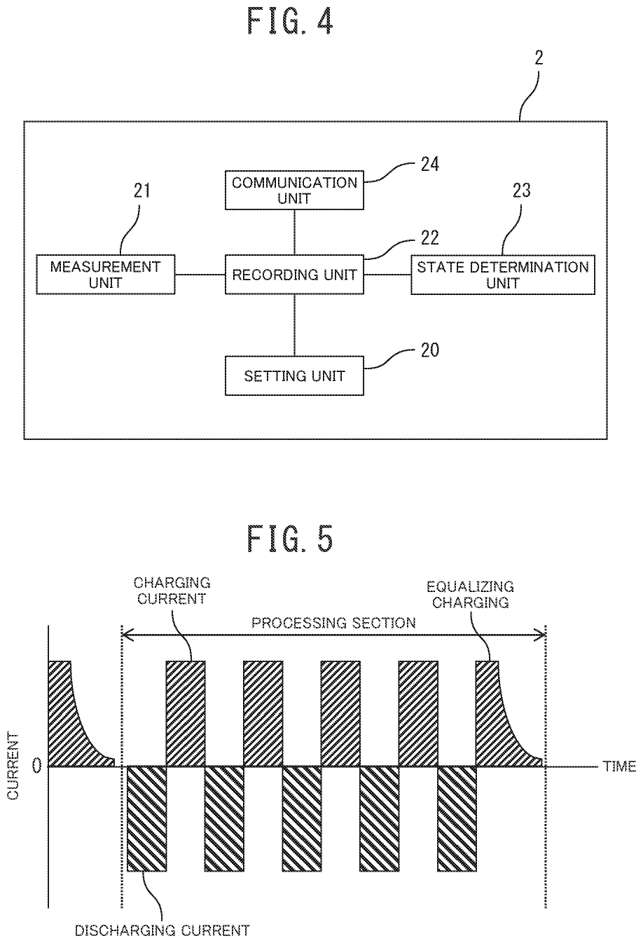

The battery monitoring device 2 is a device that performs state determination and the like of the battery based on measurement information from the assembled battery sensor 5 and the plurality of temperature sensors 7. As illustrated in FIG. 4, the battery monitoring device 2 includes, as a system configuration, a setting unit 20 that performs various settings such as a determination threshold, a measurement unit 21 that collects the measurement information from the sensors such as the assembled battery sensor 5 and the temperature sensors 7, a recording unit 22 that stores setting conditions, a measurement result, a state determination result, and the like, a state determination unit 23 that determines a state of the battery 6 using information from the measurement result, and a communication unit 24 that performs communication such as transmission of the state determination result with the host system 3. In addition, the battery monitoring device 2 controls the charging and discharging including the maintenance charging.

The host system 3 is a system that performs energy management including PCS control.

The assembled battery sensor 5 is a sensor that measures a charging and discharging current and a total voltage of the storage batteries 6.

The battery 6 is a bipolar lead acid battery. In the present embodiment, as an example, an assembled battery is used in which the storage batteries 6 connected in four series are provided in three parallels.

The plurality of temperature sensors 7 are provided in the plurality of storage batteries 6, and the temperature sensors 7 measure temperatures of the storage batteries 6. Here, the temperature sensor 7 is not limited to such an example, and may be provided in, for example, a representative battery among the plurality of storage batteries 6 or may measure an ambient temperature around the storage batteries 6.

Note that in the first embodiment, the host system 3, the assembled battery sensor 5, the temperature sensor 7, and the like constitute a battery monitoring system.

In such a power storage system 1, as illustrated in FIG. 5, when the discharging and the charging are repeated a predetermined number of times, the maintenance charging, for example, equalizing charging, is performed. The charging and the discharging are switched when a residual capacity of the battery 6 reaches upper and lower limit values that fall within a preset PSOC range. In an example illustrated in FIG. 5, when the discharging is performed five times and the charging is performed four times, the equalizing charging is performed.

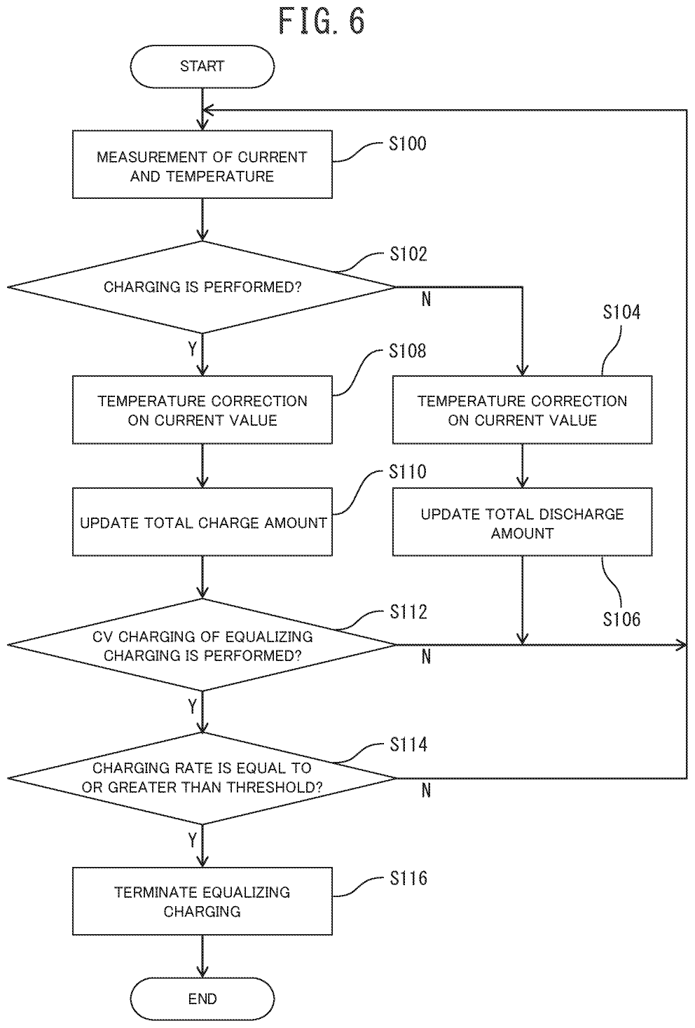

The charging and discharging of the battery 6 including the equalizing charging is performed according to a processing flow illustrated in FIG. 6. Note that processing illustrated in FIG. 6 is processing in a processing section from the charging and discharging from a state where the equalizing charging illustrated in FIG. 5 is completed to further performing the equalizing charging. Note that although not illustrated in FIG. 6, switching of the charging and the discharging and the equalizing charging is performed by the battery monitoring device 2 according to the residual capacity of the battery 6 and the number of times of the charging and discharging.

In the charging and discharging illustrated in FIG. 6, when the charging and discharging is started, first, measurement of the current by the assembled battery sensor 5 and measurement of the temperature of the battery 6 by the temperature sensor 7 are performed (S100). The measurement information of the current and the temperature is collected by the measurement unit 21 and stored in the recording unit 22.

Subsequently, the state determination unit 23 of the battery monitoring device 2 determines whether the battery 6 is being charged (S102).

If it is determined in step S102 that the battery 6 is not being charged, that is, the battery 6 is being discharged, the measurement unit 21 of the battery monitoring device 2 performs temperature correction on a current value (i.e., a discharge current value) measured in step S100 (S104). In step S104, the measured current value is multiplied by a current correction coefficient (i.e., discharge current value x current correction coefficient). As described above, the internal resistance of the battery 6 has a temperature dependence. The current correction coefficient is a coefficient corresponding to the temperature dependence. The current correction coefficient is set from the temperature dependence and the temperature of the battery 6 measured by the temperature sensor 7. The current correction coefficient is set, for example, as a function of the temperature of the battery 6, and the current correction coefficient is calculated by substituting the measured temperature into the function. The function is appropriately set according to temperature dependence of estimated charge acceptability or change in charge acceptability measured by actually changing the temperature. As a temperature used for calculating the current correction coefficient, an average temperature, a minimum temperature, or a maximum temperature of temperatures measured during the charging and discharging can be used. Note that from the viewpoint of further suppressing overcharge, it is preferable to use the minimum temperature of the temperatures measured during the charging and discharging. Further, as the temperature used for calculating the current correction coefficient, the same applies to a case of measuring the representative battery and a case of measuring the temperature of the atmosphere in which the battery 6 is placed. An actual current value flowing in the battery 6 can be determined by performing correction with the current correction coefficient.

After step S104, the battery monitoring device 2 updates an integrated value of a discharge amount (i.e., a total discharge amount) (S106). The integrated value of the discharge amount is an integrated value of the current since when the charging and discharging is performed. In addition, as will be described later, the current value is repeatedly measured while the charging and discharging is performed, the measured current value is integrated to determine the total discharge amount, and finally the integrated value in the processing section illustrated in FIG. 5 is determined. That is, the total discharge amount is updated by adding the current value measured in an immediately preceding step S100 and corrected in step S104 to the total discharge amount so far.

If it is determined in step S102 that the battery 6 is being charged, the measurement unit 21 of the battery monitoring device 2 performs temperature correction on a current value (i.e., a charge current value) measured in step S100 (S108). In step S108, similarly to the correction in step S104, the correction is performed by multiplying the measured current value by the current correction coefficient (i.e., charge current value x current correction coefficient). As the current correction coefficient, a value used for correcting the discharge current value may be used, or a value different from the correction of the discharge current value may be used.

After step S108, the battery monitoring device 2 updates an integrated value of a charge amount (i.e., a total charge amount) (S110). The integrated value of the charge amount is an integrated value of the current since when the charging and discharging is performed. In addition, as will be described later, the current value is repeatedly measured while the charging and discharging is performed, the measured current value is integrated to determine the total charge amount, and finally the integrated value in the processing section illustrated in FIG. 5 is determined. That is, the total charge amount is updated by adding the current value measured in the immediately preceding step S100 and corrected in step S108 to the total charge amount so far.

After step S110, the state determination unit 23 of the battery monitoring device 2 determines whether CV charging of the equalizing charging is being performed (S112). In a method for controlling the equalizing charging according to the first embodiment, as illustrated in FIG. 2, the CV charging is performed after CC charging is performed. During the CC charging, charging with a constant current is performed until the voltage reaches a predetermined value. During the CV charging, charging with a constant voltage is performed until a termination condition to be described later is satisfied. Then, when the termination condition is satisfied, the charging is stopped.

If it is determined in step S112 that the CV charging is being performed, the state determination unit 23 of the battery monitoring device 2 calculates an actual charging rate and determines whether the calculated charging rate is equal to or greater than a threshold value (S114). The charging rate is a ratio of the total charge amount to the total discharge amount (i.e., total charge amount/total discharge amount) and is determined from the updated total charge amount and total discharge amount. The threshold value is a predetermined charging rate set in advance and may be set as a charging rate when optimum equalizing charging is performed. Note that the charging rate in the first embodiment is also referred to as a first charging rate, and the threshold in the first embodiment is also referred to as a first threshold value.

If the charging rate is equal to or greater than the threshold value in step S114, the battery monitoring device 2 terminates the equalizing charging (S116). At this time, the total charge amount and the total discharge amount are reset to zero. When step S114 is completed, the charging and discharging including one equalizing charging is completed. In the power storage system 1, the charging and discharging including the equalizing charging is repeatedly performed by repeating the processing flow illustrated in FIG. 6.

After step S110, if it is determined in step S112 that the CV charging is not performed or if the charging rate is less than the threshold value in step S114, the processing in and after step S100 is repeatedly performed. In this way, in the processing section illustrated in FIG. 5, integration of the charge amount and the discharge amount and termination determination of the equalizing charging according to temperature conditions are repeatedly performed. That is, if the charging rate is less than the threshold value in step S114, the equalizing charging is continuously performed.

In a method for controlling maintenance charging according to the first embodiment, when performing the charging and discharging of the battery 6 including the maintenance charging, the temperature and current of the battery 6 are measured, the current is corrected based on the measured temperature, and the corrected current is integrated to calculate the total charge amount and the total discharge amount of the battery. Further, during the maintenance charging, if the charging rate calculated from the total charging amount and the total discharging amount is less than the threshold value, the constant voltage charging is continued, and if the charging rate is equal to or greater than the threshold value, the constant voltage charging is terminated. According to such a configuration, because the current value is corrected according to the temperature conditions, it is possible to cope with the change in the charge acceptability due to a temperature change. Thus, the overcharge and insufficient charge of the battery 6 can be reduced. In addition, by performing temperature correction on the current every time the measurement is performed, it is easy to follow the temperature change, and a highly accurate determination can be performed.

Note that in the first embodiment, a case of equalizing charging has been described, but the present invention is not limited to such an example. Even a case of the maintenance charging, for example, recovery charging, can be applied similarly to a case of the present embodiment.

Further, in the first embodiment, a case where the battery 6 is the bipolar lead acid battery has been described, but the present invention is not limited to such an example. The battery 6 being another general lead acid battery can be applied similarly to the present embodiment. However, the present invention is extremely effective in a case of the bipolar lead acid battery as in the first embodiment.

Further, in the first embodiment, as an example, the function of the temperature is used as the temperature correction coefficient, but the present invention is not limited to such an example. The temperature correction coefficient is only required to be set according to the temperature of the battery 6. For example, the temperature correction coefficient may be set stepwise for temperature ranges of the battery 6 to set the temperature correction coefficient from the measured temperature.

(8) In summary, a first embodiment of the present invention includes a method for controlling maintenance charging. The method can include, when performing charging and discharging of the battery including the maintenance charging, measuring the temperature and a current of the battery, correcting a measured current value based on the temperature measured, and calculating the total charge amount and the total discharge amount of the battery by integrating the current value corrected. The method can also include, during the maintenance charging, performing the constant voltage charging after the constant current charging. During the constant voltage charging, the constant voltage charging is continued when a charging rate calculated from the total charge amount and the total discharge amount is less than a threshold value, and the constant voltage charging is terminated when the charging rate is equal to or greater than the threshold value.

According to a configuration of (8), the measured current value is corrected according to the temperature conditions. Therefore, it is possible to cope with a change in charge acceptability due to a temperature change, thereby reducing overcharge and insufficient charge.

(9) In the configuration of (11), when correcting the current, a value obtained by multiplying the current by a temperature correction coefficient set according to the temperature of the battery may be used.

(10) In the configuration of the (11) or (12), the battery may be the bipolar lead acid battery.

(11) Further, the first embodiment of the present includes a power storage system. The power storage system can include a plurality of storage batteries, a temperature sensor configured to measure a temperature of the battery, a host system configured to perform energy management of the plurality of storage batteries, an assembled battery sensor configured to measure a charging and discharging current and a total voltage of the plurality of storage batteries, and a battery monitoring device configured to perform state determination of the plurality of storage batteries and control charging and discharging including maintenance charging. The battery monitoring device corrects a measured current value based on the temperature measured and calculates the total charge amount and the total discharge amount of the battery by integrating the current value corrected. During the maintenance charging, the constant voltage charging is performed after the constant current charging. During the constant voltage charging, the constant voltage charging is continued when a charging rate calculated from the total charge amount and the total discharge amount is less than a threshold value, and the constant voltage charging is terminated when the charging rate is equal to or greater than the threshold value.

### Second Embodiment

Next, a second embodiment of the present invention will be described. As in the first embodiment, as illustrated in FIG. 3, the power storage system 1 according to the second embodiment includes the battery monitoring device 2 (also called a BMU), the host system 3 (also called an EMS), the AC-DC converter 4 (also called a PCS), the assembled battery sensor 5, the plurality of storage batteries 6, and the plurality of temperature sensors 7. Note that hereinafter, description of the same configuration as that of the first embodiment may be omitted, and description of configuration different from that of the first embodiment will be mainly described.

As in the first embodiment, the battery monitoring device 2 is a device that performs state determination and the like of the battery based on the measurement information from the assembled battery sensor 5 and the plurality of temperature sensors 7. The battery monitoring device 2 includes, as a system configuration, the setting unit 20, the measurement unit 21, the recording unit 22, the state determination unit 23, and the communication unit 24 as illustrated in FIG. 4. The host system 3, the assembled battery sensor 5, the battery 6, and the plurality of temperature sensors 7 also have the same configurations as those of the first embodiment. Also in the second embodiment, the host system 3, the assembled battery sensor 5, the temperature sensor 7, and the like constitute the battery monitoring system.

In such a power storage system 1, as in the first embodiment, when the discharging and the charging are repeated a predetermined number of times, the maintenance charging, for example, the equalizing charging, is performed as illustrated in FIG. 5. The charging and the discharging are switched when a residual capacity of the battery 6 reaches upper and lower limit values that fall within a preset PSOC range. In the example illustrated in FIG. 5, when the discharging is performed five times and the charging is performed four times, the equalizing charging is performed.

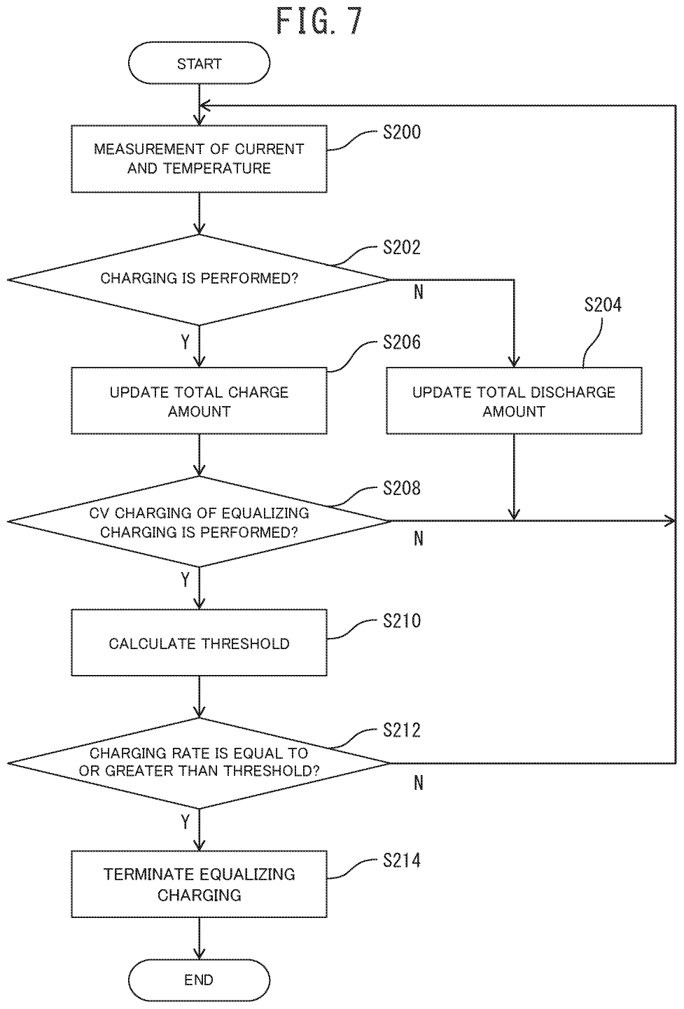

The charging and discharging of the battery 6 including the equalizing charging is performed according to a processing flow illustrated in FIG. 7. Note that processing illustrated in FIG. 7 is processing in a processing section from the charging and discharging from the state where the equalizing charging illustrated in FIG. 5 is completed to further performing the equalizing charging. Although not illustrated in FIG. 7, the switching of the charging and the discharging and the equalizing charging is performed by the battery monitoring device 2 according to the residual capacity of the battery 6 and the number of times of the charging and discharging.

In the charging and discharging illustrated in FIG. 7, when the charging and discharging is started, first, the measurement of the current by the assembled battery sensor 5 and the measurement of the temperature of the battery 6 by the temperature sensor 7 are performed (S200). The measurement information of the current and the temperature is collected by the measurement unit 21 and stored in the recording unit 22.

Subsequently, the state determination unit 23 of the battery monitoring device 2 determines whether the battery 6 is being charged (S202).

If it is determined in step S202 that the battery 6 is not being charged, that is, the battery 6 is being discharged, the battery monitoring device 2 updates the integrated value (i.e., a total discharge amount) of the discharge amount (S204). The integrated value of the discharge amount is an integrated value of the current since when the charging and discharging is performed. In addition, as will be described later, the current value is repeatedly measured while the charging and discharging is performed, the measured current value is integrated to determine the total discharge amount, and finally the integrated value in the processing section illustrated in FIG. 5 is determined. That is, the total discharge amount is updated by integrating the current value measured in the immediately preceding step S200 with the total discharge amount so far.

If it is determined in step S202 that the battery 6 is being charged, the battery monitoring device 2 updates the integrated value (i.e., a total charge amount) of the charge amount (S206). The integrated value of the charge amount is an integrated value of the current since when the charging and discharging is performed. The integrated value of the charge amount is also similar to the total discharge amount, and the total charge amount is updated by integrating the current value measured in the immediately preceding step S200 with the total charge amount so far.

After step S206, the state determination unit 23 of the battery monitoring device 2 determines whether the CV charging of the equalizing charging is being performed (S208). In the method for controlling the equalizing charging according to the second embodiment, as illustrated in FIG. 2, the CV charging is performed after the CC charging is performed. During the CC charging, charging with a constant current is performed until the voltage reaches a predetermined value. During the CV charging, charging with a constant voltage is performed until a termination condition to be described later is satisfied. Then, when the termination condition is satisfied, the charging is stopped.

When it is determined in step S208 that the CV charging is being performed, the setting unit 20 of the battery monitoring device 2 calculates the threshold value of the charging rate (S210). The threshold value of the charging rate is a value obtained by multiplying a set value by the temperature correction coefficient (i.e., set value x temperature correction coefficient). The set value is a predetermined charging rate set in advance and may be set as, for example, a charging rate when the optimum equalizing charging is performed at a predetermined temperature. The current correction coefficient is a value set from the temperature dependence of the internal resistance of the battery 6, that is, the temperature dependence of the charge acceptability and the temperature of the battery 6 measured by the temperature sensor 7. The temperature dependence of the charge acceptability is set, for example, as a function of the temperature of the battery 6. The function is appropriately set according to temperature dependence of estimated charge acceptability or change in charge acceptability measured by actually changing the temperature. As a temperature used for calculating the temperature correction coefficient, the average temperature, the minimum temperature, or the maximum temperature of the temperatures measured during the charging and discharging can be used. Note that from the viewpoint of further suppressing overcharge, it is preferable to use the minimum temperature of the temperatures measured during the charging and discharging. Further, as the temperature used for calculating the temperature correction coefficient, the same applies to the case of measuring the representative battery and the case of measuring the temperature of the atmosphere in which the battery 6 is placed. Note that the threshold value in the second embodiment is also referred to as a second threshold value.

After step S210, the state determination unit 23 of the battery monitoring device 2 calculates the actual charging rate and determines whether the calculated charging rate is equal to or greater than a threshold value calculated in step S210 (S212). The charging rate is a ratio of the total charge amount to the total discharge amount (total charge amount/total discharge amount) and is determined from the updated total charge amount and total discharge amount.

If the charging rate is equal to or greater than the threshold value in step S212, the battery monitoring device 2 terminates the equalizing charging (S214). At this time, the total charge amount and the total discharge amount are reset to zero. When step S214 is completed, the charging and discharging including one equalizing charging is completed. In a power storage system 1, the charging and discharging including the equalizing charging is repeatedly performed by repeating the processing flow illustrated in FIG. 7. Note that the charging rate in the second embodiment is also referred to as a second charging rate.

After step S204, if it is determined in step S208 that the CV charging is not performed or if the charging rate is less than the threshold value in step S212, the processing in and after step S200 is repeatedly performed. In this way, in the processing section illustrated in FIG. 5, integration of the charge amount and the discharge amount and termination determination of the equalizing charging according to temperature conditions are repeatedly performed. That is, if the charging rate is less than the threshold value in step S212, the equalizing charging is continuously performed.

In the method for controlling the equalizing charging according to the second embodiment, the CV charging is performed after the CC charging as the equalizing charging of the battery 6. During the CV charging, the CV charging is continued when the charging rate is less than the threshold value corresponding to the temperature of the battery 6, and the CV charging is terminated when the charging rate is equal to or greater than the threshold value. In addition, a value obtained by multiplying the set value that is the predetermined charging rate by the temperature correction coefficient is used as the threshold value. According to such a configuration, the charging rate at which the equalizing charging is terminated is changed according to the temperature conditions. Therefore, it is possible to cope with a change in charge acceptability due to a temperature change, thereby reducing overcharge and insufficient charge.

Note that in the second embodiment, the case of equalizing charging has been described, but the present invention is not limited to such an example. Even a case of the maintenance charging, for example, recovery charging, can be applied similarly to a case of the present embodiment.

Further, in the second embodiment, the case where the battery 6 is the bipolar lead acid battery has been described, but the present invention is not limited to such an example. The battery 6 being another general lead acid battery can be applied similar to the present embodiment. However, the present invention is extremely effective in the case of the bipolar lead acid battery as in the second embodiment.

(12) In summary, the second embodiment of the present invention includes a method for controlling maintenance charging. The method can include performing the constant voltage charging after the constant current charging as the maintenance charging of the battery. During the constant voltage charging, the constant voltage charging is continued when the charging rate calculated from the total charge amount and the total discharge amount of the battery is less than a threshold value according to the temperature of the battery, and the constant voltage charging is terminated when the charging rate is equal to or greater than the threshold value.

According to a configuration of (12), the charging rate at which the recovery charging is terminated is changed according to the temperature conditions. Therefore, it is possible to cope with a change in charge acceptability due to a temperature change, thereby reducing overcharge and insufficient charge.

(13) In the configuration of (12), the value obtained by multiplying the set value that is the predetermined charging rate by the temperature correction coefficient may be used as the threshold value.

(14) In the configuration of (12) or (13), the battery may be the bipolar lead acid battery.

(15) The second embodiment of the present invention also includes a power storage system. The power storage system includes a plurality of storage batteries, a temperature sensor configured to measure a temperature of the battery, a host system configured to perform energy management of the plurality of storage batteries, an assembled battery sensor configured to measure a charging and discharging current and a total voltage of the plurality of storage batteries, and a battery monitoring device configured to perform state determination of the plurality of storage batteries and control charging and discharging including maintenance charging. The constant voltage charging is performed after the constant current charging as the maintenance charging. During the constant voltage charging, the constant voltage charging is continued when the charging rate calculated from the total charge amount and the total discharge amount of the battery is less than the threshold value according to the temperature of the battery. The constant voltage charging is terminated when the charging rate is equal to or greater than the threshold value.

Note that in the method for controlling maintenance charging according to the first aspect of the present invention, the constant voltage charging is performed after the constant current charging as the maintenance charging of the battery 6, and in the constant voltage charging, whether to continue or terminate the constant voltage charging is determined based on the temperature of the battery and the threshold value (the first threshold value in the first embodiment or the second threshold value in the second embodiment). The temperature of the battery is determined using the charging rate (the first charging rate in first embodiment or the second charging rate in the second embodiment) calculated from the total charge amount and the total discharge amount of the battery calculated from the current value of the battery 6.

Further, according to the second aspect of the present invention, the power storage system 1 includes the plurality of storage batteries 6, the temperature sensor 7 configured to measure the temperature of the battery 6, the host system 3 configured to perform energy management of the plurality of storage batteries 6, the assembled battery sensor 5 configured to measure the charging and discharging current and the total voltage of the plurality of storage batteries 6, and the battery monitoring device 2 configured to perform state determination of the plurality of storage batteries 6 and control the charging and discharging including the maintenance charging. The constant voltage charging is performed after the constant current charging as the maintenance charging. During the constant voltage charging, whether to continue or terminate the constant voltage charging is determined based on the temperature of the battery 6 and the threshold value (the first threshold value in the first embodiment or the second threshold value in the second embodiment). The temperature of the battery 6 is determined using the charging rate (the first charging rate in first embodiment or the second charging rate in the second embodiment) calculated from the total charge amount and the total discharge amount of the battery 6 calculated from the current value of the battery 6.

The following is a list of reference signs used in this specification and in the drawings.
1 Power storage system
2 Battery monitoring device
3 Host system
4 AC-DC converter
5 Assembled battery sensor
6 Storage battery
7 Temperature sensor
20 Setting unit
21 Measurement unit
22 Recording unit
23 State determination unit
24 Communication unit

What is claimed is:

1. A method for controlling maintenance charging, comprising:
performing constant voltage charging after constant current charging as the maintenance charging of a battery; and
determining, during the constant voltage charging, whether to continue or terminate the constant voltage charging based on a temperature of the battery and a threshold value, wherein the temperature of the battery is determined using a charging rate calculated from a total charge amount and a total discharge amount of the battery that are calculated from a current value of the battery.

2. The method for controlling maintenance charging according to claim 1, wherein:
performing the maintenance charging comprises:
measuring the temperature and a current of the battery;
correcting a measured current value based on the temperature measured;
calculating the total charge amount and the total discharge amount of the battery by integrating the measured current value as corrected; and
during the constant voltage charging, continuing the constant voltage charging when a first charging rate calculated from the total charge amount and the total discharge amount of the battery is less than a first threshold value, and terminating the constant voltage charging when the first charging rate is equal to or greater than the first threshold value.

3. The method for controlling maintenance charging according to claim 2, wherein correcting the measured current value comprises using a value obtained by multiplying the current value by a temperature correction coefficient set according to the temperature of the battery.

4. The method for controlling maintenance charging according to claim 1, wherein during the constant voltage charging, continuing the constant voltage charging when a second charging rate calculated from the total charge amount and the total discharge amount of the battery is less than a second threshold value according to the temperature of the battery and terminating the constant voltage charging when the second charging rate is equal to or greater than the second threshold value.

5. The method for controlling maintenance charging according to claim 4, wherein the second threshold value is a value obtained by multiplying a set value that is a predetermined charging rate by a temperature correction coefficient.

6. The method for controlling maintenance charging according to claim 1, wherein the battery is a bipolar lead acid battery.

7. A power storage system, comprising:
a plurality of storage batteries;
a temperature sensor configured to measure a temperature of at least one battery of the plurality of storage batteries;
a host system configured to perform energy management of the plurality of storage batteries;
an assembled battery sensor configured to measure a charging and discharging current and a total voltage of the plurality of storage batteries; and
a battery monitoring device configured to perform state determination of the plurality of storage batteries and control charging and discharging including maintenance charging, wherein:
constant voltage charging is performed after constant current charging as the maintenance charging;
during the constant voltage charging, whether to continue or terminate the constant voltage charging is determined based on the temperature of the at least one battery of the plurality of storage batteries and a threshold value; and
the temperature of the at least one battery of the plurality of storage batteries is determined using a charging rate calculated from a total charge amount and a total discharge amount of the at least one battery that are calculated from a current value of the at least one battery.
